(19) United States
(12) Patent Application Publication
(10) Pub. No.: US 2025/0037156 A1
(43) Pub. Date: Jan. 30, 2025

(54) Artificial Intelligence Real-Time Self-Trained Private-Public Foundation Model Generative Demand Operation Planning Monitoring Control Method

(71) Applicants: Charles H Ng, Palo Alto, CA (US); Hokchung Ng, Toronto (CA)

(72) Inventors: Charles H Ng, Palo Alto, CA (US); Hokchung Ng, Toronto (CA)

(21) Appl. No.: 18/592,445

(22) Filed: Feb. 29, 2024

Related U.S. Application Data
(60) Provisional application No. 63/529,126, filed on Jul. 26, 2023.

(51) Int. Cl. G06Q 30/0202

(52) U.S. Cl. CPC G06Q 30/0202

(57) ABSTRACT

An artificial intelligence platform for utilizing real-time self-trained private-public foundation models in generating demand forecast, operation planning, monitoring, and control. This platform helps users to optimize their operations in delivery of products or services. The platform generates forecast, requirements, schedules, delivery, payment, and support data for carrying out the operations. It generates control data to control field systems to carry out the operations, and monitor real-time field operation resulting data that are fed back from the field systems to the platform. This platform combines different types of input data, generates training data, utilizes a group of public and private foundation models and a number of AI algorithms. The Platform utilizes foundation models to encode data into N-dimension feature spaces, identifies closest types of operations, defines predictive functions, associate specific data to specific predictive functions, and use security measures to protect proprietary information.

### CROSS-REFERENCE TO RELATED APPLICATIONS

This application claims the benefit of Provisional Patent Application Ser. #U.S. 63/529,126 filed Jul. 26, 2023 by the present inventors, which is incorporated by reference in its entirety.

### TECHNICAL FIELD

The present invention relates artificial intelligence method in real-time self-trained private-public foundation model for generative demand forecast, operation planning, operation monitoring, and operation control.

### BACKGROUND ART

Organization operation demand forecast are commonly calculated by human operators and applications of simple arithmetic. An operator commonly does simple estimation of demand from his various channels of announcement for his operation, products, or services. The operator uses his experience to calculate a list of required resources, raw materials, labor, equipments, and infrastructures, and he schedules operation plans with time lines for his operation, delivery of work-in-progress, products, or services. He also schedules delivery plans, shipping, and payment schedules. During the operation, he monitors the progress of the operation, and he compares this progress with his original operation plans. In addition, he monitors any abnormal emergencies that can disrupt the operations. He uses his experience and simple arithmetic to fine tune his requirements while carrying out the schedules, and he provides alternative plans to handle any abnormal emergencies. This common process is generally not reliably repeatable and not very effective.

### SUMMARY

Our artificial intelligence method provides real-time self-trained private-public foundation model for generating demand forecast, operation planning, operation monitoring, and operation control.

### DRAWINGS—FIG.S

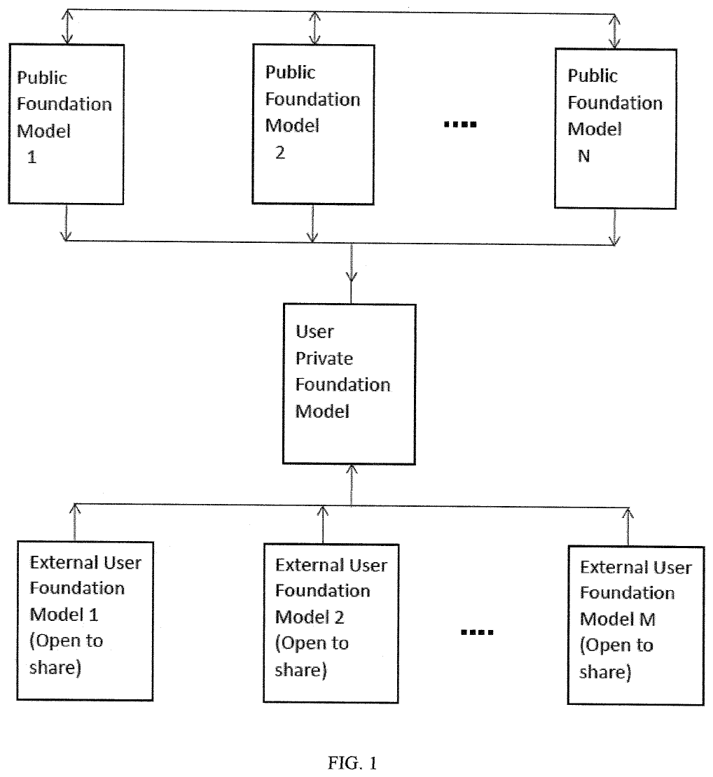

1) FIG. 1: AI Platform Core Engine is built on multiple Private Foundation Models and Public Foundation Models.

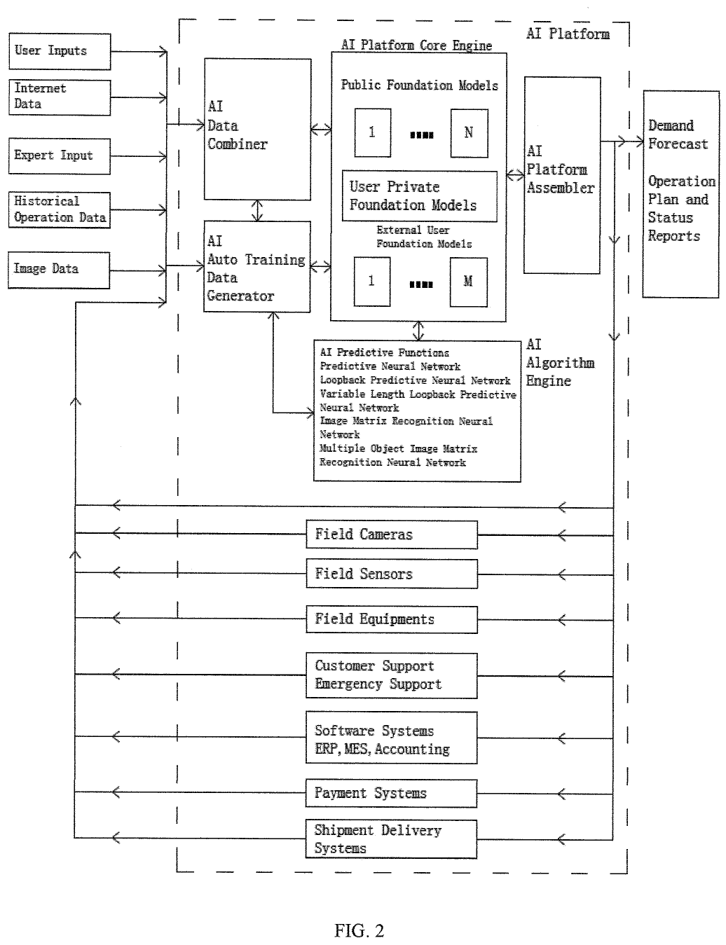

2) FIG. 2: Information flow among AI Platform components

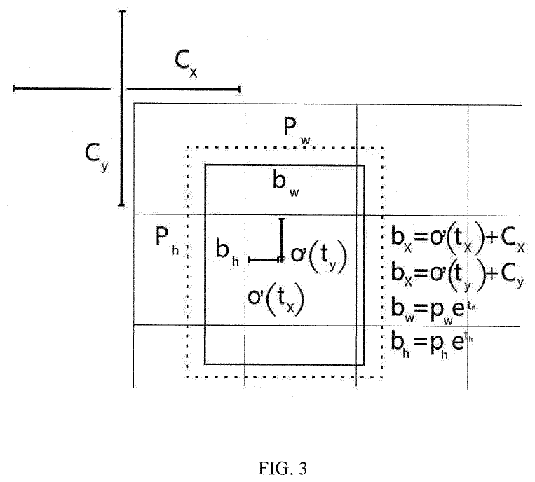

3) FIG. 3: Grid cell in multiple object image matrix recognition neural network

### DESCRIPTION

Our artificial intelligence method utilizes real-time self-trained private and public foundation models in generating demand forecast, operation planning, operation monitoring, and operation control. This method offers an artificial intelligence (“AI”) platform to help multiple users optimize their operations in delivery of products or services. Our AI Platform generates forecast, resource requirements, schedules, delivery, payment, and support information to carry out the operation.

Our AI Platform interoperates and inter-processes data among one or more of the AI Platform components, comprising: AI Data Combiner, AI Auto Training Data Generator, AI Platform Core Engine, AI Platform Assembler, AI Algorithm Engine, and field systems. AI Data Combiner is used to combine platform input data coming from different sources and feed to the AI Platform components. AI Auto Training Data Generator, working with AI Data Combiner, processes platform input data with statistical variants to generate AI auto training data to provide self training to AI Platform components. AI Platform Core Engine is built on a group of public foundation models, external user foundation models, and user private foundation models.

We identify external user foundation models that belong to external users that do not have the same access rights to proprietary information from our users, and identify public foundation models that can be accessed by general public and do not have the same access rights to proprietary information from said users, and structure user private foundation models to have the access rights to proprietary information from our users.

AI Algorithm Engine uses a combination of one or more methods, comprising: predictive functions, predictive neural network, loopback predictive neural network, variable length loopback predictive neural network, image matrix recognition neural network, and multiple object image matrix recognition neural network. See FIG. 1. Results from multiple foundation models are assembled by the AI Platform Assembler to generate the field operation control data feeding to control the field systems, and the field systems generate real-time field operation resulting data, feeding back as part of platform input data through AI Data Combiner and AI Auto Training Data Generator to the AI Platform for further analysis and training. See FIG. 2. Our AI Platform components are running on a mixture of private and public, local and cloud computing infrastructures. Data communication is carried through local network and the Internet.

Our AI Platform utilizes different types of platform input data sources, comprising: real-time input data from user, customers, and experts, real-time data from Internet, real-time data from user operations, real-time data from customers operations, historical data from user operations, historical data from customers operations, real-time field operation control data from AI Platform Assembler, and real-time field operation resulting data from field systems. Our AI Platform is first put into an initial training phase with a large data set, and in addition to initial training phase, the AI Platform goes through continued training and self-training during the operation phase. Our AI Auto Training Data Generator is used to generate training data quickly and is custom tuned to address the needs of our target application.

During training phase and in operation phase, the AI Platform collects data from the Internet and user internal data, and the AI Platform analyzes historical and real-time Internet data, comprising: generic social data, generic economic data, generic seasonal data, organizations' financial data, customers' financial data, competitors' financial data, distribution channel demand data, and final actual customer demands. Social data includes society polling data, online social media data, or sampling data on the Internet online metaverse. Economic data includes national GDP numbers, inflation data, national import export data, household income data, household expenditure data, etc. Seasonal data includes fluctuation in economic data, target industry fluctuations data, etc. Financial data includes users' revenue, income, raw material cost, labor cost, bank interest cost, etc. Similar financial data from users' customers and competitors' are also used. Users' distribution channels, their sales force, and third parties sales force demand forecast, as well as the final actual customer demand data, are fed into our AI Platform.

AI Platform Core Engine, AI Algorithm Engine, and AI Platform Assembler work together to generates field operation control data with one or more options, comprising: demand forecast data, operation planning data, operation schedules, production schedules, resource planning data, operation monitoring data, resource control data, operation fulfillment support data, operation reporting data, pollution control data, emergency support data, and expected field outcomes from the field systems.

The field operation control data are fed to control field systems, targeting to minimize discrepancies between expected field outcomes and actual field outcomes from field systems. The field systems are built with a number of components, comprising: field sensors, field equipments, operation software systems, and operation fulfillment support systems. The field systems generate real-time field operation resulting data with the actual field outcomes, feeding back to the AI Data Combiner and AI Auto Training Data Generator. Due to this feeds back to guide the AI Auto Training Data Generator, we can cross-train the user private foundation model by using information from other public foundation models and external user foundation models.

We feed field operation control data to control field systems operations and enable further operation processing by field systems with image sensors and data sensors, comprising: visible light cameras, infrared cameras, ultra-violet cameras, x-ray cameras, face-recognition cameras, finger print readers, temperature sensors, pressure sensors, voltage sensors, electrical current sensors, environment parameter sensors, machine operation sensors, optical sensors, machine code readers, bar code readers, QR code readers, and RFID sensors.

We feed field operation control data to control field systems operations and enable further operation processing by field systems with the field equipments, comprising: field solid state relays to turn on or off equipments, field variable frequency drivers to change the operating speed of field equipments, field operation equipments, field electromechanical equipments, field electrochemical equipments, field electromagnetic equipments, field machines, field robots to carry out mechanical work, and field edge computing devices.

We feed field operation control data to control field systems operations and enable further operation processing by field systems with the operation software systems, comprising: manufacturing execution system MES, enterprise resource planning system ERP, equipment planning systems, infrastructure planning system, human resource systems, and accounting systems.

We feed field operation control data to control field systems operations and enable further operation processing by field systems with the operation fulfillment support systems, comprising: operation status reporting systems, customer support systems, transportation systems, shipment systems, delivery systems, payment systems, pollution control systems, and emergency support systems

During training phase and in operation phase, every piece of data used in our AI Platform components is structured to be AI data processing unit with two components, comprising: the data content container and the data property tag. The data content container carries the original data content in raw binary data, numeric, text, audio, image, or video format. The data property tag contains many pieces of information, comprising: data encoding vectors, AI predictive function tags, data source tag, data time stamp, and security tag with one or more levels of access control. The AI predictive function tags associates this AI data processing unit to specific AI predictive dependent variables, independent variables, and AI predictive functions. The data source and data time stamp are used to identify the original source of the data source and the time of creation and the time of arrival of this data. The security identification tag indicates which organization and which foundation model is the owner for this piece of data, and which public or private foundation models can access this data.

During training phase and in operation phase, the AI Platform sets up and improves multiple AI predictive functions that can be used in predicting dependent variables based on multiple independent variables. The AI predictive function can be expressed as:

$$Y = F ( Xi , M ) + ei$$

where Y is the dependent variable as a function of independent variables Xi, coefficient term M, and error term ei. The goal of the AI predictive function is to estimate the function F (Xi, b) that minimize the sum of square of error terms. The AI predictive function can be a combination of 1) single independent variable function, 2) multiple independent variables function, 3) linear function, and 4) nonlinear function.

As one of the options for the AI predictive function, a multiple independent variable linear function can be expressed as

$$Y = M 0 + M 1 \times X 1 + M 2 \times X 2 + … + Mn \times Xn .$$

The same principle can also be applied to single independent variable function, multiple independent variable function, linear function and nonlinear function.

During training phase and in operation phase, the AI predictive function is initially set up as a multiple independent variable linear function with the target of minimizing the sum of square of error terms. In addition, the AI algorithm Engine as another option sets up the AI predictive function as a non-linear function using the predictive neural network. The predictive neural network consists of the input layer, hidden layers, and output layer. We use multiple hidden layers, and each layer consists of a number of neurons. Each layer uses a nonlinear enable function associated with each of the layer. The nonlinear enable function can be any combination of one or more options, comprising:

$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0.$$

Each layer forward propagates to the next layer until it reaches the final output layer that uses a linear enable function.

During training phase and in operation phase, we train each of the foundation models to recognize each set of one or more features in specifying each foundation model N-dimension feature space. Each foundation model is used to encode every piece of AI Platform data processing unit used throughout AI Platform and the types of user operations by location proximity of each piece of AI Platform data processing unit in each of the N-dimension feature space of each foundation model. We identify one or more features used in the N-dimension feature spaces of public foundation models and external user foundation models and add these features into feature spaces of our user private foundation models. User private foundation models are used to map resulting values of each encoding into the locations in N-dimension feature spaces of user private foundation models to become final encoding values.

We utilize the location proximity of feature encoding vector of the types of user operations in the N-dimension feature space to identify the closest type of operation among one or more options of possible worldwide operations. We train the foundation models to base on this closest type of operation to identify operation properties for the types of user operations for user operations, and during operation phase to provide additional training to modify and improve the operation properties for the types of user operations for our user operations. We train the foundation models to recognize operation properties as any combination of one or more options, comprising; user operation cause and effect relationships, cause-factor data as specific input factors, specific input specifications, specific input quantities, and specific input time schedules that are required in generating effect-factor data as specific output factor, specific output specifications, specific output quantities, and specific output time schedules, AI predictive functions, the independent variables, the dependent variables, type and source of platform input data, field operation control data, and expected field outcomes that are used in carrying out the specific user operations.

These user operation cause and effect relationships are the key to identify key operation factors in generating the field operation control data and in carrying out specific user operations. We generate feature encoding vector in encoding every piece of operation properties of user operations, utilizing the feature encoding vector to locate key operation property location proximity, and identifying specific key AI Platform data processing units clustering around the same location proximity.

We also assign AI predictive association between AI Platform data processing units clustering around specific location proximity in said N-dimension feature space and with any combination of one or more AI predictive functions, dependent variables, and independent variables that cluster around the same specific location proximity. Therefore, we know how to utilize specific AI Platform data processing units in specific AI predictive functions, and we utilize specific AI Platform data processing units, specific AI predictive functions and specific independent variables to predict specific dependent variables in the data processing throughout AI Platform components.

We utilize AI Data Combiner and AI Auto Training Data Generator to base on improvements in the operation properties for the types of user operations for our user operations and improvements from new training to the foundation models to generate new data search from the input data sources to collect new information as said platform input data feeding to said AI Platform components for further data processing and self training.

Multiple foundation model resulting data from multiple public and private foundation models are similar but slightly different. We fed these multiple foundation model resulting data into the user private foundation model working with the AI Platform Assembler in order to combine them and generate the final combined foundation model resulting data.

We identify multiple foundation model resulting data from multiple foundation models that are near the same said N-dimension location proximity as cluster groups of foundation model resulting data, and we utilize these cluster groups to calculate level of significance of said foundation model resulting data. We count the number of foundation model resulting data reporting near the same N-dimension location proximity as the cluster count, and applying the cluster count to a nonlinear level of significance enable function to come up with the level of significance. We structure the nonlinear level of significance enable function to be any combination of one or more options, comprising:

$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0 ;$$

We train the user private foundation models to understand historical foundation model success rates of each of the foundation models in successfully generating useful foundation model resulting data. We train our user private foundation model to understand how to utilize historical foundation model success rates and the significance level of the foundation model resulting data in each of the cluster group as independent variables feeding to predictive functions to predict dependent variables as combined foundation model resulting data.

We assign priorities, based on the historical foundation model success rates and level of significance of these combined foundation model resulting data, in generating field operation control data, and assign priorities in carrying out these field operation control data with the field systems.

We utilize these AI predictive functions to predict dependent variables throughout the AI Platform components. AI Data Combiner works with specific AI predictive functions to calculate discrepancies between field operation control data with expected field outcomes and real-time field operation resulting data with actual field outcomes coming from said field systems. We then feed these discrepancies data to said AI Platform components for further analysis, generate the next batch of field operation control data to further minimize the discrepancies.

The AI Data Combiner uses the AI predictive functions to combine data values from multiple incoming sources to form the best combined data as AI Data Combiner resulting data feeding to AI Platform components. In the AI Auto Training Data Generator, the AI predictive functions are used to generate new training data based on data values of multiple incoming sources and values of statistical variant terms to provide self training to AI Platform components. In the AI Platform Core Engine, the AI predictive functions are used to predict data for multiple target result data, comprising: data for market demand, operation planning, operation monitoring, and operation control. In the AI Platform Assembler, the AI predictive functions are used to generate resulting data based on data coming from multiple foundation models.

Public foundation models are owned by companies in the public market and are available to our users by commercial subscription agreements. Public foundation models running on public cloud computing infrastructures can be used to process non-proprietary data. Each user owns its dedicated user private foundation models, and proprietary information is only processed in the user private foundation models. If external users of other organizations open the access to their foundation models, then the user can access these other organization external user foundation models.

Information used in our AI Platform Core Engine only flows in one direction from the public foundation models to the user private foundation model. Except for statistical aggregated information, information does not flow back from a user private foundation model to any public foundation model or external user foundation models, and hence proprietary information resides only in user private foundation models and cannot be leaked back to public foundation models or other external user foundation models. Information from other organizations external user foundation models who are willing to share only flows in one direction from these other organizations external user foundation models to the user private foundation model. Access of information from one foundation model by another foundation model is controlled by the security identification tag.

Loopback predictive neural network and variable length loopback predictive neural network are effective in capturing time delayed data dependence relationships in the platform input data, and are also effective in numeric and textual recognition in field images, such as: electronic displays, labels, documents, or sign displays. Image matrix recognition neural network is used to identify operating conditions in field images, comprising: emergency situations in the environment, distinguishing between a normal operating environment and an abnormal operating environment, a properly running equipment and a improperly failing equipment, a safe operating environment and an emergency environment, a clean operating environment and a polluted operating environment. The multiple object image matrix recognition neural network is used to identify and count objects in field mages, and monitor product counts, material counts, machine counts, staff member counts, or customer counts in the operating environment.

We utilize loopback predictive neural network and variable length loopback predictive neural network to capture time delayed data dependence relationships in platform input data. We also use these neural networks to recognize numeric and textual messages in the field systems, such as recognizing electronic displays from equipments, printed labels on materials, documents, and sign displays from the operating environment. We set up loopback predictive neural network and variable length loopback predictive neural network with multiple loopback predictive neural layers, comprising: loopback predictive input neural layer, layers of loopback predictive hidden neural layers, and loopback predictive output neural layer. We set up each loopback predictive neural layer with multiple loopback predictive neurons and with loopback predictive enable function from any combination of one or more options, comprising:

$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0.$$

We propagate data forward from loopback predictive input neural layer to one or more layers of loopback predictive hidden neural layer, and propagating until reaching loopback predictive output neural layer that uses a linear predictive enable function to generate final results. We loop back data from each loopback predictive hidden neural layer to one or more previous loopback predictive hidden neural layer, and in the variable length loopback predictive network, we loop back data from each hidden neural layer going through multiple different distance paths to multiple previous variable length loopback predictive hidden neural layer. We compare results of loopback predictive neural network and variable length loopback predictive neural network with expected field outcomes and feeding results to AI Platform components for further processing.

We utilize image matrix recognition neural network and image data in the platform input data to recognize operating conditions in field systems, such as normal operating environment, abnormal operating environment, properly running equipment, improperly failing equipment, safe operating environment, emergency broken out environment, clean operating environment, and polluted operating environment.

The image matrix recognition neural network is set up to operate with these steps:

step 1 calculating: inputting image matrix with pixel values, after cropping, changing size of each image, and reading input matrix from upper left corner of image to start, selecting a smaller matrix called calculation filter, moving with x and y axis of input image, setting task of filter to multiply its value by original pixel value, adding all these multiplications and ending up with a number, setting filter to read image in top left corner, moving further to right by 1 or N units, and repeating this process again, after filter going through all positions, obtaining a new matrix with size of new matrix smaller than input matrix, setting size of first layer filter in length*width, depth, and number of steps, filling with a value when crossing boundary, repeating setting size of second layer, third layer to seventh layer filter in length*width, depth, steps, and filling with a value.

step 2 activation: applying nonlinear operation with activation layer to matrix after each calculation operation, using equation, f(x)=max(0,x), introducing nonlinearity in calculation, generating a resulting set of feature maps.

step 3 down sampling: down sampling calculation with feature maps, reducing dimension of matrix, but retaining important information, performing maximum data down sampling aggregation calculation, retrieving maximum value element in activation feature map, and applying it to all elements, setting down sampling window size length*width and sliding step value of each layer.

step 4 repeating: increasing or decreasing number of layers, repeating steps in calculation, activation, and down sampling.

step 5 flattening fully connected layer: flattening feature map after repeating enough times, converting matrix of feature map into vector, sending to form a fully connected layer, outputting fully connected layer with Softmax activation function, generating result of forward propagation neural network in probability distribution, setting Softmax as a normalized exponential function with an expression as:

$$\begin{matrix}f : {ℝ}^{K} \to {ℝ}^{K} , \\ f ( {z}_{j} ) = \frac{{e}^{{z}_{j}}}{{\sum }_{i = 1}^{k} {e}^{{z}_{j}}} ( j = 1 , 2 , … , k )\end{matrix} ,$$

letting z1 indicate that node of first category, and zk indicate node of kth category.

step 6 getting results: after applying activation function to fully connected layer, classifying results into one or more types of said operating conditions 1 to N, and sending results of image matrix recognition neural network as AI Algorithm Engine resulting data to AI Platform components to carry out further processing. We compare results of image matrix recognition neural network as part of said field operation resulting data with expected field outcomes and feeding results to AI Platform components for further processing.

We utilize multiple object image matrix recognition neural network and image data in platform input data to recognize operating conditions and count objects in field systems, such as product counts, material counts, machine counts, staff member counts, and customer counts;

The multiple object image matrix recognition neural network is set up to operate with these steps:

step 1 gridding: dividing input image into an S×S grid, utilizing each grid unit to predict an image object with the center point of said image object falling within said grid unit, structuring each grid unit to have three bounding boxes each with length Cx and width Cy, structuring said bounding box to contain five image object elements, (bx, by, bw, bh, bc), structuring bx and by to be offsets of corresponding said grid unit, structuring said bounding box width bw and height bh being normalized to said image object width and height, see FIG. 3, structuring bc as confidence score reflecting the possibility of said image object contained in said bounding box and accuracy of said bounding box, adjusting sizes of said object elements during learning process, setting said bounding boxes initially to be 10×13, 16×30, 33×23, 30×61, 62×45, 59×119, 116×90, 156×198, 373×326.

step 2 calculating: inputting image matrix with pixel values, reading input matrix from upper left corner of image, select a smaller matrix called calculation filter, moving with the x and y axes of input image, using calculation filter to multiply its value by the original pixel value, adding all these multiplications and ending up with a number, setting filter to read image in top left corner, moving further to right by 1 or N units, repeating this process again, after filter going through all positions, obtaining a new matrix with size of new matrix smaller than input matrix, adjusting sizes of layers during learning process, setting first layer initially to have length*width*depth be 3*3*32 and number of steps be 1, setting second layer initially to be length*width*depth is 3*3*64 and number of steps be 2, setting 3rd and 4th layer to be 1*1*32, number of steps 1 fourth layer to be 3*3*64 with number of steps 1 and residual module 128*128, layer 5 to be 3*3*128 with number of steps 2, setting layer 6 to 9 to repeat 2 times of [1*1*64, step number 1, 3*3*128, step number 1, residual module 64*64], setting layer 10 to be 3*3*256 with step number 2, setting layer 11 to 26 to repeat 8 times of [1*1*128, step number 1, 3*3*256, step number 1, residual module 32*32], setting layer 27 to be 3*3*512 with step number 2, setting layer 28 to 43 to repeat 8 times of [1*1*256, step number 1, 3*3*512, step number 1, residual module 16*16], setting layer 44 to be 3*3*1024 with step number 2, setting layer 45 to 52 to repeat 4 times of [1*1*512, step number 1, 3*3*1024, step number 1, residual module 8*8].

step 3 down sampling: utilizing feature map to down sampling said image matrix and retaining important information, setting layer 53 to intercepting the average element in said feature map and applying to all elements.

step 4 repeating: setting multiple object image matrix recognition neural network to initially have 53 layers, adjusting the number of steps of calculating and down sampling until said feature map showing key parameters.

step 5 flattening fully connected layer: flattening feature map after repeating enough times, converting matrix of feature map into vector, sending to form a fully connected layer, outputting fully connected layer with Softmax activation function, generating result of forward propagation neural network in probability distribution, setting Softmax as a normalized exponential function with an expression as:

$$\begin{matrix}f : {ℝ}^{K} \to {ℝ}^{K} , \\ f ( {z}_{j} ) = \frac{{e}^{{z}_{j}}}{{\sum }_{i = 1}^{k} {e}^{{z}_{j}}} ( j = 1 , 2 , … , k )\end{matrix} ,$$

letting z1 indicate that node of first category, and zk indicate node of kth category.

step 6 getting results: after applying activation function to fully connected layer, classifying results into one or more types of said operating conditions 1 to N, and counting total number of recognized said image objects, and sending results of multiple object image matrix recognition neural network as AI Algorithm Engine resulting data to AI Platform components to carry out further processing. We compare results of multiple object image matrix recognition neural network as part of field operation resulting data with expected field outcomes and feeding results to AI Platform components for further processing.

### Operation:

The following described embodiments are only some of the, but not all, embodiments of our presented method. Based on the embodiments of our presented method, all other embodiments obtained by those of ordinary skill in the art without creative efforts shall fall within the protection scope of our presented method.

This artificial intelligence real-time self-trained private-public foundation model generative demand, operation planning, operation monitoring, and operation control method offers an artificial intelligence (“AI”) platform to help multiple users optimize their operations, delivery of products or services. We use two examples, a manufacturing factory and a hotel operation, to illustrate how our method can be put into operation. The AI platform target applications include generating demand forecast, providing operation plans, real-time monitoring, and controlling operation progress. The AI platform provides planning, monitoring, and controlling of the following: demand forecast, materials, resources, labor, customers, equipments, infrastructure, shipment, delivery, payments, pollution control, and emergency support.

Our AI platform utilizes results from multiple public foundation models and private foundation models, running on a mixture of private and public local and cloud computing infrastructures. We subscribe access to public foundation models from the market place. Our user, a manufacturing factory or a hotel, owns its separate user private foundation model. Information used in our AI platform only flows in one direction from the public foundation models to the user private foundation model. Every piece of data used in our AI platform is marked with a security identification tag that indicates which organization and which foundation model is the owner for this piece of data, and which public or private foundation model can access this data. Results from multiple public and private foundation models are fed into the user private foundation model working with our AI platform assembler to generate the final field operation control data.

In order to use our AI platform, we have to first train the components in the AI platform. Our AI platform utilizes a number of methods to generate training data, comprising: expert data, Internet data, operation data, image data, AI auto generated training data, and real-time feedback data from the field systems. All these data are combined by our AI training data combiner running predictive functions, predictive neural network, loopback predictive neural network, variable length loopback predictive neural network, and other AI algorithms, and results are fed to train the AI Platform components.

During training and operations, our AI platform analyzes Internet data, comprising: generic economic data, generic seasonal data, organizations' financial data, customers' financial data, competitors' financial data, distribution channel demand data, and final actual customer demands. After analyzing Internet data, our AI platform generates demand forecast, operation planning, and scheduling for our users.

In a manufacturing factory example, our AI platform generates the demand forecast for the manufactured products, operation plans, required resources, and time schedules to fulfill the demand forecast, comprising: production raw materials, semi-finished materials, work-in-progress materials, support materials, equipments, pollution control equipments, emergency safety equipments, factory buildings, gas or electrical infrastructures, product shipments, enterprise resource planning systems ERP, customer invoicing, customer payments, and factory labor requirements.

In a hotel example, our AI platform generates the demand forecast for the hotel rooms, operation plans, required resources, and time schedules to fulfill the demand forecast, comprising: hotel buildings, hotel rooms, meeting rooms, restaurants, parking spaces, hotel servicing materials, food materials, hotel support materials, pollution control equipments, emergency safety equipments, customer payments, and hotel labor requirements.

In addition to demand forecast and operation plan, during operations, our AI platform monitor real-time operation resulting data and controls the operation environment.

In a manufacturing factory example, our AI platform controls the operation in a factory, such as: using temperature sensors, pressure sensors, field sensor to monitor the production equipments, using bar code readers QR code readers, RFID readers to count raw materials, semi-finished materials, and work-in-progress materials, using face recognition reader to count labor, cameras to monitor operating equipments, cameras to count staff workers, cameras to monitor possible pollution and emergency, sending control signals to turn on and off equipments, interfacing to enterprise resource planning ERP software systems, arranging product shipments, customer invoicing, and payments.

In a hotel example, our AI platform controls the operation in a hotel, such as: using temperature sensors, humidity sensors to monitor the hotel rooms, using bar code readers QR code readers, RFID readers to count service support materials, face recognition reader to count labor, cameras to monitor hotel lobbies, cameras to count staff and customers, cameras to monitor possible pollution and emergency, interface to booking software systems, arrange support material shipments, and manage customer credit card payments.

The result is our AI platform optimizes multiple organizations operations for the delivery of products or services. It forecasts demand forecast, provides operation planning, schedules resources, real-time monitors progress, controls operations, controls deliveries, payments, and handle abnormal emergencies.

### CONCLUSION, RAMIFICATIONS, AND SCOPE

While the above description contains much specificity, these should not be construed as limitations on the scope of the invention, but rather as an exemplification of one preferred embodiment thereof. Many other variations are possible.

For example, we describe our method using an example of a manufacturing factory and a hotel, but the principle of our method can be generalized to apply to other types of operations of government, commercial, non-commercial, public, private, product providing, and service providing, virtual, and non-virtual operations.

For example, we describe our method in generates field operation control data, comprising: demand forecast data, operation planning data, operation schedules, production schedules, resource planning data, operation monitoring data, and operation control data, but the principle of our method can be generalized to apply to generating all types of mandatory and non-mandatory, necessary and non-necessary data to carry out an operations.

For example, we describe utilizing image sensors and data sensors, comprising: visible light cameras, infrared cameras, ultra-violet cameras, x-ray cameras, face-recognition cameras, finger print readers, but the principle of our method can be generalized to apply to utilizing all types of data collecting devices and sensors.

The described embodiment in the above description is only one of the, but not all, embodiments of our presented method. Based on the embodiments of our presented method, all other embodiments obtained by those of ordinary skill in the art without creative efforts shall fall within the protection scope of our presented method.

The scope of the invention should be determined not by the embodiments illustrated, but by the appended claims and their legal equivalents.

I claim:

1) A method for users using AI Platform in generating real-time demand forecast, operation planning, operation monitoring, and operation control for user operations comprises any combination of one or more options, comprising:
utilizing said AI Platform in optimizing said user operations for types of user operations in one or more possible options of worldwide operations;
interoperating and inter-processing data with any combination of one or more of AI Platform components, comprising: AI Data Combiner, AI Auto Training Data Generator, AI Platform Core Engine, AI Algorithm Engine, AI Platform Assembler, and field systems;
training and self-training said AI Platform in an initial training phase with a large data set, and in addition to said initial training phase, continuing said training and said self-training of said AI Platform during the operation phase;
enabling one or more said users sharing the use of said AI Platform, while proprietary data of each user are protected and separated by security tag and control information;
operating said AI Platform components on any combination of one or more of private and public, local and cloud computing infrastructures, and communicating data through local network and the Internet;
feeding to said AI Data Combiner and said AI Auto Training Data Generator with real-time platform input data;
utilizing AI Data Combiner working with said AI Algorithm Engine in processing real-time said platform input data to generate AI Data Combiner resulting data feeding to said AI Platform components;
utilizing said AI Auto Training Data Generator working with said AI Data Combiner and said AI Algorithm Engine in processing real-time said platform input data with statistical variants to generate AI auto training data feeding to said AI Platform components to provide real-time said training and said self training;
utilizing said AI Platform Assembler, working with said AI Platform Core Engine and said AI Algorithm Engine, in feeding to said field systems with field operation control data with any combination of one or more options, comprising: demand forecast data, operation planning data, operation schedules, production schedules, resource planning data, operation monitoring data, resource control data, operation fulfillment support data, operation reporting data, pollution control data, emergency support data, and expected field outcomes from said field systems; and
feeding real-time said field operation control data to control said field systems to carry out said user operations with said expected field outcomes and generate real-time field operation resulting data with actual field outcomes as part of said platform input data feeding back to said AI Data Combiner and said AI Auto Training Data Generator.

2) The method of claim 1 wherein said feeding to said AI Data Combiner and AI Auto Training Data Generator with said platform input data further comprises any combination of one or more options, comprising:
feeding to said AI Data Combiner and AI Auto Training Data Generator with real-time said platform input data from any combination of one or more options of input data sources, comprising: real-time input data from users, customers and experts, real-time data from Internet, real-time data from said user operations, real-time data from customers operations, historical data from said user operations, historical data from said customers operations, real-time field operation control data from said AI Platform Assembler, and real-time said field operation resulting data from said field systems;
feeding to said AI Data Combiner and said AI Auto Training Data Generator with said platform input data from said real-time data from Internet from any combination of one or more options, comprising: social polling data, social media data, online sampling data, economic data, seasonal data, GDP data, inflation data, import export data, household financial data, other organizations' financial data, distribution channel demand data, customer demand data, and any data that said users find necessary in affecting said user operations; and
feeding to said AI Data Combiner and said AI Auto Training Data Generator with said platform input data from said user operations and said customer operations from any combination of one or more options, comprising: said users industry economic data, said users financial data, said users accounting data, said users distribution channel demand data, said customer industry economic data, said customer financial data, said customer accounting data, and said customer distribution channel demand data.

3) The method of claim 1 wherein said generating said AI Data Combiner resulting data and said AI auto training data feeding to said AI Platform components further comprises with any combination of one or more options, comprising:
processing said platform input data with said AI Platform components to generate said field operation control data to control said field systems, targeting to minimize discrepancies between said expected field outcomes and said actual field outcomes from said field systems;
generating AI Algorithm Engine resulting data from said AI Algorithm Engine with any combination of one or more of AI Algorithm Engine components, comprising: AI predictive functions, predictive neural network, loopback predictive neural network, variable length loopback predictive neural network, image matrix recognition neural network, and multiple object image matrix recognition neural network;
identifying external user foundation models that belong to external users that do not have the same access rights to proprietary information from said users;
identifying public foundation models that can be accessed by general public and do not have the same access rights to proprietary information from said users;
structuring user private foundation models to have the access rights to proprietary information from said users;
generating foundation model resulting data from said AI Platform Core Engine with any combination of one or more options of foundation models, comprising: said public foundation models, said external user foundation models, and said user private foundation models; and
feeding said foundation model resulting data to said AI Platform Assembler to generate real-time said field operation control data to control said field systems with any combination of one or more options, comprising: field sensors, field equipments, operation software systems, and operation fulfillment support systems.

4) The method of claim 3 wherein said generating real-time said field operation control data to control said field systems further comprises with any combination of one or more options, comprising:
feeding said field operation control data to control said field systems operations and enable further operation processing by said field systems with said field sensors from any combination of one or more options, comprising: visible light cameras, infrared cameras, ultra-violet cameras, x-ray cameras, face-recognition cameras, finger print readers, temperature sensors, pressure sensors, voltage sensors, electrical current sensors, environment parameter sensors, machine operation sensors, optical sensors, machine code readers, bar code readers, QR code readers, and RFID sensors;
feeding said field operation control data to control said field systems operations and enable further operation processing by said field systems with field equipments from any combination of one or more options, comprising: field solid state relays, field variable frequency drivers, field operation equipments, field electromechanical equipments, field electrochemical equipments, field electromagnetic equipments, field machines, field robots, and field edge computing devices;
feeding said field operation control data to control said field systems operations and enable further operation processing by said field systems with said operation software systems from any combination of one or more options, comprising: manufacturing execution system MES, enterprise resource planning system ERP, equipment planning systems, infrastructure planning system, human resource systems, and accounting systems; and
feeding said field operation control data to control said field systems operations and enable further operation processing by said field systems with said operation fulfillment support systems from any combination of one or more options, comprising: operation status reporting systems, customer support systems, transportation systems, shipment systems, delivery systems, payment systems, pollution control systems, and emergency support systems.

5) The method of claim 3 wherein said processing said platform input data with said AI Platform components further comprises:
during said initial training phase and said operation phase, structuring every piece of data used in said AI Platform as AI Platform data processing unit, inter-processing every said AI Platform data processing unit by one or more of said AI Platform components, and training one or more of said AI Platform components with steps of any combination of one or more options, comprising:
setting up and improving said AI predictive functions to predict dependent variables from any combination of one or more of independent variables;
structuring said AI Platform data processing unit from data of any combination of one or more of options, comprising: said AI Data Combiner resulting data, said AI auto training data, said AI Algorithm Engine resulting data, said foundation model resulting data, said field operation control data, said field operation resulting data, said AI predictive function, said dependent variable, and said independent variable;
structuring said AI Platform data processing unit to contain one or more components, comprising:
data content container, and data property tag;
structuring said data content container of said AI Platform data processing unit to contain data content of any combination of one or more options, comprising: binary data, numeric data, text, audio, image, and video; and
structuring said data property tag of said AI Platform data processing unit to contain any combination of one or more options, comprising: feature encoding vector, AI predictive function tags, data source tag, data time stamp, and security tag with one or more levels of access control.

6) The method of claim 5 wherein said setting up and said improving said AI predictive functions further comprises any combination of one or more options, comprising:
setting up AI predictive function as Y=F (Xi, Mi)+ei, where Y is said dependent variable as a function of said independent variables Xi, coefficient term Mi, and error term ei, while minimizing sum of square of said error term;
setting up AI predictive function as a combination of one or more options, comprising: single independent variable function, multiple independent variables function, linear function, and nonlinear function;
setting up AI predictive function as one of the options as said multiple independent variable linear function as Y=M0+M1×X1+M2×X2+ . . . +Mn×Xn;
setting up AI predictive function as one of the options as said non-linear function utilizing said predictive neural network;
setting up said predictive neural network with one or more nonlinear predictive neural layers, comprising: input nonlinear predictive neural layer, one or more layers of nonlinear predictive hidden neural layers, and output predictive neural layer;
setting up each said nonlinear predictive neural layer with one or more nonlinear predictive neurons using nonlinear enable function from any combination of one or more options, comprising:
$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) ,$$
and x where x<=0 and α(e^{x}−1) where x>0;
propagating data forward from said input nonlinear predictive neural layer to next layer of said nonlinear predictive hidden neural layer; and
propagating data forward until reaching said output predictive neural layer using a linear predictive enabling function.

7) The method of claim 5 wherein said inter-processing every said AI Platform data processing unit by one or more of said AI Platform components and said training one or more of said AI Platform components further comprises any combination of one or more options, comprising:
training each of one or more said foundation models to recognize each set of one or more features in specifying each N-dimension feature space for each foundation model;
utilizing each said foundation model in generating feature encoding vector in encoding every piece of said AI Platform data processing unit and said types of user operations by location proximity in each said N-dimension feature space of each said foundation model;
adding and combining one or more features used in said N-dimension feature spaces of one or more said public foundation models and said external user foundation models into said N-dimension feature spaces of said user private foundation models;
utilizing said user private foundation models to map location values of said feature encoding vector of every piece of said AI Platform data processing unit and said types of user operations into locations in N-dimension feature spaces of said user private foundation models to become final feature encoding vector;
utilizing location proximity of said feature encoding vector of said types of user operations in said N-dimension feature space to identify the closest types of operations among one or more options of said possible worldwide operations;
training said foundation models to base on said closest types of operations to identify operation properties for said types of user operations for said user operations, and during said operation phase to provide additional training to modify and improve said operation properties for said types of user operations for said user operations;
training said foundation models to recognize said operation properties as any combination of one or more options, comprising; user operation cause and effect relationships, cause-factor data as specific input factors, specific input specifications, specific input quantities, and specific input time schedules that are required in generating effect-factor data as specific output factor, specific output specifications, specific output quantities, and specific output time schedules, said AI predictive functions, said independent variables, said dependent variables, type and source of said platform input data, said field operation control data, and said expected field outcomes that are used in carrying out specific said user operations;
generating feature encoding vector in encoding every piece of said operation properties of said user operations, utilizing said feature encoding vector to locate key operation property location proximity, and identifying specific key AI Platform data processing units clustering around the same location proximity;
assigning AI predictive association between said specific key AI Platform data processing units clustering around a specific location proximity and with any combination of one or more options, comprising: specific said AI predictive functions, specific said dependent variables, and specific said independent variables, that cluster around the same location proximity;
utilizing said AI predictive association in identifying specific AI Platform data processing units as specific said AI predictive functions and specific said independent variables in calculating specific said dependent variables in processing data throughout said AI Platform components; and
utilizing said AI Data Combiner and said AI Auto Training Data Generator to base on said improvements in said operation properties for said types of user operations for said user operations and new improvements from training to said foundation models to initiate new real-time data searching process from said input data sources to collect new real-time information as said platform input data feeding to said AI Platform components for further data processing and self training.

8) The method of claim 7 wherein said encoding every said AI Platform data processing unit by location proximity in each said N-dimension feature space further comprises any combination of one or more options, comprising:
utilizing said foundation models working with said AI Platform Assembler and said AI predictive association to identify AI predictive functions to process one or more said independent variables to generate one or more said dependent variables, and utilize said dependent variables to generate said foundation model resulting data and said field operation control data;
identifying one or more said foundation model resulting data from one or more said foundation models that cluster around specific said N-dimension location proximity as cluster groups of said foundation model resulting data, and utilizing said cluster group to calculate level of significance of said foundation model resulting data;
counting the number of said foundation model resulting data in each of said cluster group as cluster count, and applying said cluster count to a nonlinear level of significance enable function to come up with said level of significance to be applied to said cluster groups of said foundation model resulting data;
structuring said nonlinear level of significance enable function to be any combination of one or more options, comprising:
$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0 ;$$
training said user private foundation models to identify historical foundation model success rates in one or more said foundation models in generating useful and accurate results from each of said foundation models;
training said user private foundation models to utilize said historical foundation model success rates and said level of significance of one or more said foundation model resulting data in each of said cluster group as said independent variables feeding to said AI predictive functions to predict said dependent variables as combined foundation model resulting data; and
assigning priorities based on said historical foundation success rates and said level of significance of said combined foundation model resulting data in generating said field operation control data and assigning priorities in carrying out said field operation control data with said field systems.

9) The method of claim 5 wherein said inter-processing every said AI Platform data processing unit by one or more of said AI Platform components further comprises any combination of one or more options, comprising:
utilizing said AI Data Combiner to work with specific said AI predictive functions to calculate discrepancies between said field operation control data with said expected field outcomes coming from said AI Platform Assembler and real-time said field operation resulting data with said actual field outcomes coming from said field systems, feeding said discrepancies to said AI Platform components for further analysis to generate the next batch of said field operation control data to further minimize said discrepancies;
utilizing said AI Data Combiner to work with specific said AI predictive functions to process said platform input data as said independent variables and generate said dependent variables as said AI Data Combiner resulting data feeding to said AI Platform components; and
utilizing said AI Auto Training Data Generator to work with specific said AI predictive functions to process said platform input data and statistical variants as said independent variables and generate said dependent variables feeding to provide self training to said AI Platform components.

10) The method of claim 5 wherein said structuring said data property tag of said AI Platform data processing unit further comprises:
utilizing said data source tag and said security tag to enable said user operations with an option to protect important or proprietary information and control said foundation models having appropriate access rights to provide data to, receive data from, and modify data from said AI Platform components by steps of any combination of one or more options, comprising:
utilizing said data source tag and said security tag to disable access of proprietary information of said AI Platform data processing unit by said public foundation models and said external user foundation models;
utilizing said data source tag and said security tag to disable said AI Platform data processing unit from said user private foundation models flowing to said public foundation models and said external user foundation models;
utilizing said data source tag and said security tag to enable said AI Platform data processing unit from said public foundation models and said external user foundation models flowing to said user private foundation models; and
utilizing said data source tag and said security tag to control access of proprietary information by said AI Platform components while enabling cross-training of said foundation models by other said foundation models.

11) The method of claim 5 of said inter-processing every piece of data as AI Platform data processing unit by said AI Platform components further comprises any combination of one or more options, comprising:
utilizing said AI Data Combiner to work with specific said loopback predictive neural network and said variable length loopback predictive neural network to process said platform input data and generate said AI Data Combiner resulting data feeding to said AI Platform components;
utilizing said AI Auto Training Data Generator to work with specific said loopback predictive neural network and said variable length loopback predictive neural network to process said platform input data and statistical variants to generate said AI auto training data to train AI Platform components;
utilizing said loopback predictive neural network and said variable length loopback predictive neural network to capture time delayed data dependence relationships in said platform input data;
utilizing said loopback predictive neural network, said variable length loopback predictive neural network, and said image data in said platform input data to recognize numeric and textual messages in said field systems with any combination of one or more options, comprising:
electronic displays, labels, documents, and sign displays;
setting up said loopback predictive neural network with one or more loopback predictive neural layers, comprising: loopback predictive input neural layer, one or more layers of loopback predictive hidden neural layers, and loopback predictive output neural layer;
setting up each said loopback predictive neural layer with one or more loopback predictive neurons and with loopback predictive enable function from any combination of one or more options, comprising:
$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0 ;$$
propagating data forward from said loopback predictive input neural layer to one or more layers of said loopback predictive hidden neural layer, and propagating until reaching said loopback predictive output neural layer which uses a linear predictive enable function to generate final results;
looping back data from each said loopback predictive hidden neural layer to one or more previous said loopback predictive hidden neural layer;
setting up said variable length loopback predictive neural network with one or more variable length loopback predictive neural layers, comprising: variable length loopback predictive input neural layer, one or more layers of variable length loopback predictive hidden neural layers, and variable length loopback predictive output neural layer;
setting up each said variable length loopback predictive neural layer with one or more variable length loopback predictive neurons and with variable length loopback predictive enable function from any combination of one or more options, comprising:
$$\frac{1}{1 + {e}^{- x}} , tanh ( x ) , max ( 0 , x ) , max ( 0.1 x , x ) , max ( {w}_{1}^{T} x + {b}_{1} , {w}_{2}^{T} x + {b}_{2} ) , and x where x <= 0 and α ( {e}^{x} - 1 ) where x > 0 ;$$
propagating data forward from said variable length loopback predictive input neural layer to one or more layers of said variable length loopback predictive hidden neural layer, and propagating until reaching said variable length loopback predictive output neural layer which uses a linear predictive enable function to generate final results;
looping back data from each said variable length loopback predictive hidden neural layer going through one or more different distance paths to one or more previous said variable length loopback predictive hidden neural layer; and
comparing said results of said loopback predictive neural network and said variable length loopback predictive neural network as part of said field operation resulting data with said expected field outcomes and feeding said results to said AI Platform components for further processing.

12) The method of claim 5 of said inter-processing every piece of data as AI Platform data processing unit by said AI Platform components further comprises any combination of one or more options, comprising:
utilizing said AI Data Combiner to work with specific said image matrix recognition neural network to process image data in said platform input data and generate said AI Data Combiner resulting data feeding to said AI Platform components;
utilizing said AI Auto Training Data Generator to work with said image matrix recognition neural network to process image data in said platform input data and statistical variants to generate said AI auto training data to train AI Platform components;
utilizing said image matrix recognition neural network and said image data in said platform input data to recognize operating conditions in said field systems with conditions of any combination of one or more options, comprising: normal operating environment, abnormal operating environment, properly running equipment, improperly failing equipment, safe operating environment, emergency broken out environment, clean operating environment, and polluted operating environment;
utilizing said image matrix recognition neural network to recognize operating conditions from image data of said platform input data with steps selected from any combination of one or more options, comprising:
step 1 calculating: inputting image matrix with pixel values, after cropping, changing size of each image, and reading input matrix from upper left corner of image to start, selecting a smaller matrix called calculation filter, moving with x and y axis of input image, setting task of filter to multiply its value by original pixel value, adding all these multiplications and ending up with a number, setting filter to read image in top left corner, moving further to right by 1 or N units, and repeating this process again, after filter going through all positions, obtaining a new matrix with size of new matrix smaller than input matrix, setting size of first layer filter in length*width, depth, and number of steps, filling with a value when crossing boundary, repeating setting size of second layer, third layer to seventh layer filter in length*width, depth, steps, and filling with a value;
step 2 activation: applying nonlinear operation with activation layer to matrix after each calculation operation, using equation, f(x)=max(0,x), introducing nonlinearity in calculation, generating a resulting set of feature maps;
step 3 down sampling: down sampling calculation with feature maps, reducing dimension of matrix, but retaining important information, performing maximum data down sampling aggregation calculation, retrieving maximum value element in activation feature map, and applying it to all elements, setting down sampling window size length*width and sliding step value of each layer;
step 4 repeating: increasing or decreasing number of layers, repeating steps in calculation, activation, and down sampling;
step 5 flattening fully connected layer: flattening feature map after repeating enough times, converting matrix of feature map into vector, sending to form a fully connected layer, outputting fully connected layer with Softmax activation function, generating result of forward propagation neural network in probability distribution, setting Softmax as a normalized exponential function with an expression as:
$$\begin{matrix}f : {ℝ}^{K} \to {ℝ}^{K} , \\ f ( {z}_{j} ) = \frac{{e}^{{z}_{j}}}{{\sum }_{i = 1}^{k} {e}^{{z}_{j}}} ( j = 1 , 2 , … , k )\end{matrix} ,$$
letting z1 indicate that node of first category, and zk indicate node of kth category;
step 6 getting results: after applying activation function to fully connected layer, classifying results into one or more types of said operating conditions 1 to N;
comparing said results of said image matrix recognition neural network as part of said field operation resulting data with said expected field outcomes and feeding to said AI Platform components for further processing; and
sending results of said image matrix recognition neural network as said AI Algorithm Engine resulting data to said AI Platform components to carry out further processing.

13) The method of claim 5 of said inter-processing every piece of data as AI Platform data processing unit by said AI Platform components further comprises any combination of one or more options, comprising:
utilizing said AI Data Combiner to work with specific said multiple object image matrix recognition neural network to process image data in said platform input data and generate said AI Data Combiner resulting data feeding to said AI Platform components;
utilizing said AI Auto Training Data Generator to work with said multiple object image matrix recognition neural network to process image data in said platform input data and statistical variants to generate said AI auto training data to train AI Platform components;
utilizing said multiple object image matrix recognition neural network and said image data in said platform input data to recognize operating conditions and counting objects in said field systems with conditions of any combination of one or more options, comprising: product counts, material counts, machine counts, staff member counts, and customer counts;
utilizing said multiple object image matrix recognition neural network to recognize operating conditions from image data of said platform input data and counting number of recognized objects by applying steps selected from any combination of one or more options, comprising:
step 1 gridding: dividing input image into an S×S grid, utilizing each grid unit to predict an image object with the center point of said image object falling within said grid unit, structuring each grid unit to have three bounding boxes each with length Cx and width Cy, structuring said bounding box to contain five image object elements, (bx, by, bw, bh, bc), structuring bx and by to be offsets of corresponding said grid unit, structuring said bounding box width bw and height bh being normalized to said image object width and height, structuring bc as confidence score reflecting the possibility of said image object contained in said bounding box and accuracy of said bounding box, adjusting sizes of said object elements during learning process, setting said bounding boxes initially to be 10×13, 16×30, 33×23, 30×61, 62×45, 59×119, 116×90, 156×198, 373×326;
step 2 calculating: inputting image matrix with pixel values, reading input matrix from upper left corner of image, select a smaller matrix called calculation filter, moving with the x and y axes of input image, using calculation filter to multiply its value by the original pixel value, adding all these multiplications and ending up with a number, setting filter to read image in top left corner, moving further to right by 1 or N units, repeating this process again, after filter going through all positions, obtaining a new matrix with size of new matrix smaller than input matrix, adjusting sizes of layers during learning process, setting first layer initially to have length*width*depth be 3*3*32 and number of steps be 1, setting second layer initially to be length*width*depth is 3*3*64 and number of steps be 2, setting 3rd and 4^{th} layer to be 1*1*32, number of steps 1 fourth layer to be 3*3*64 with number of steps 1 and residual module 128*128, layer 5 to be 3*3*128 with number of steps 2, setting layer 6 to 9 to repeat 2 times of [1*1*64, step number 1, 3*3*128, step number 1, residual module 64*64], setting layer 10 to be 3*3*256 with step number 2, setting layer 11 to 26 to repeat 8 times of [1*1*128, step number 1, 3*3*256, step number 1, residual module 32*32], setting layer 27 to be 3*3*512 with step number 2, setting layer 28 to 43 to repeat 8 times of [1*1*256, step number 1, 3*3*512, step number 1, residual module 16*16], setting layer 44 to be 3*3*1024 with step number 2, setting layer 45 to 52 to repeat 4 times of [1*1*512, step number 1, 3*3*1024, step number 1, residual module 8*8];
step 3 down sampling: utilizing feature map to down sampling said image matrix and retaining important information, setting layer 53 to intercepting the average element in said feature map and applying to all elements;
step 4 repeating: setting multiple object image matrix recognition neural network to initially have 53 layers, adjusting the number of steps of calculating and down sampling until said feature map showing key parameters;
step 5 flattening fully connected layer: flattening feature map after repeating enough times, converting matrix of feature map into vector, sending to form a fully connected layer, outputting fully connected layer with Softmax activation function, generating result of forward propagation neural network in probability distribution, setting Softmax as a normalized exponential function with an expression as:
$$\begin{matrix}f : {ℝ}^{K} \to {ℝ}^{K} , \\ f ( {z}_{j} ) = \frac{{e}^{{z}_{j}}}{{\sum }_{i = 1}^{k} {e}^{{z}_{j}}} ( j = 1 , 2 , … , k )\end{matrix} ,$$
letting z1 indicate that node of first category, and zk indicate node of kth category;
step 6 getting results: after applying activation function to fully connected layer, classifying results into one or more types of said operating conditions 1 to N, and counting total number of recognized said image objects;
comparing said results of said multiple object image matrix recognition neural network as part of said field operation resulting data with said expected field outcomes and feeding to said AI Platform components for further processing; and
sending results of said multiple object image matrix recognition neural network as said AI Algorithm Engine resulting data to said AI Platform components to carry out further processing.
